(19) United States
(12) Patent Application Publication
(10) Pub. No.: US 2025/0018504 A1
(43) Pub. Date: Jan. 16, 2025

(54) LASER OPTICAL SYSTEM AND ADJUSTMENT METHOD THEREFOR, AND LASER MACHINING DEVICE AND METHOD

(71) Applicant: Tokyo Seimitsu Co., Ltd., Tokyo (JP)

(72) Inventors: Chikara AIKAWA, Tokyo (JP); Hirokazu HAYASHI, Tokyo (JP)

(73) Assignee: Tokyo Seimitsu Co., Ltd., Tokyo (JP)

(21) Appl. No.: 18/900,028

(22) Filed: Sep. 27, 2024

Related U.S. Application Data
(63) Continuation of application No. PCT/JP2023/010553, filed on Mar. 17, 2023.

(30) Foreign Application Priority Data
Mar. 30, 2022 (JP) 2022-056521

(51) Int. Cl. B23K 26/067; B23K 26/06; B23K 26/38

(52) U.S. Cl. CPC B23K 26/067; B23K 26/0648; B23K 26/0652; B23K 26/38

(57) ABSTRACT

A laser optical system and an adjustment method therefor, and a laser machining device and method capable of adjusting laser light so as to satisfy criteria of laser machining are provided. The adjustment method of a laser optical system including a plurality of optical element units which are arranged in series on an optical path of laser light and each of which includes a half-wave plate and a Wollaston prism, the laser optical system configured to branch the laser light incident on the Wollaston prism through the half-wave plate into two beams of branched laser light, includes a step of rotating the half-wave plate around the optical path to adjust branching ratios of the branched laser light and a step of rotating the Wollaston prism around the optical path to adjust branching directions of the branched laser light.

### CROSS-REFERENCE TO RELATED APPLICATIONS

The present application is a Continuation of PCT International Application No. PCT/JP2023/010553 filed on Mar. 17, 2023 claiming priority under 35 U.S.C § 119(a) to Japanese Patent Application No. 2022-056521 filed on Mar. 30, 2022. Each of the above applications is hereby expressly incorporated by reference, in its entirety, into the present application.

### BACKGROUND OF THE INVENTION

### Field of the Invention

The present invention relates to a laser optical system and an adjustment method therefor, and a laser machining device and method, particularly, relates to a laser optical system and an adjustment method therefor, and a laser machining device and method for performing laser machining by irradiating a workpiece such as a semiconductor wafer with laser light.

### Description of the Related Art

In a manufacturing field of a semiconductor device, there has been a wafer (semiconductor wafer) on which devices are formed of a stacked body which is obtained by stacking a low dielectric constant insulator film (Low-k film) and a functional film that forms circuits on a surface of a substrate such as silicon is known. On such a wafer, grid-shaped streets partition the devices in a grid shape, and individual devices are manufactured by dividing (dicing) the wafer along scheduled dividing lines.

The Low-k film has a nature of being fragile and susceptible to falling off, and thus, in some cases, the Low-k film may fall off in dicing the wafer using a blade, resulting in damages on the devices. To address such a nature of the Low-k film of being fragile and susceptible to falling off, a method is known in which, two rows of a first groove that divide the Low-k film are formed on both sides of a scheduled dividing line with laser ablation machining, and thereafter a second groove is formed between the two rows of the first groove (for example, Patent Literature 1).

### CITATION LIST

### Patent Literature

Patent Literature 1: Japanese Patent Application Laid-Open No. 2015-154009

### SUMMARY OF THE INVENTION

For performing laser machining on a workpiece, evaluation criteria (standards) of a process of the laser machining and a machining result are the following (1) to (3):
(1) Performing the laser machining in a short period of time.
(2) Suppressing influence of heat on devices, and the like, on chips
(3) Obtaining desired a machining result (such as, for example, a depth of a machining groove or a depth position, or a size of a laser machining region)

To achieve the above-described criteria (1) and (3), it is conceivable to make adjustment so that laser machining is performed with one pass. However, in a case where laser machining is performed with one pass, it is necessary to increase energy per one beam, increasing the likelihood of heat generation during laser machining. It is therefore difficult to achieve the criterion (2): suppressing influence of heat.

To achieve the criterion (2): suppressing influence of heat, for example, it is considered effective to perform laser machining with a plurality of passes while lowering energy per one beam. However, lowering energy per one beam increases time for laser machining, which makes it difficult to achieve the criterion (1).

The present invention has been made in view of such circumstances, and aims to provide a laser optical system, an adjustment method therefor, and a laser machining device and method capable of adjusting laser light so as to satisfy criteria of laser machining.

To solve the above-described problem, a laser optical system according to a first aspect of the present invention includes: a plurality of optical element units which are arranged in series on an optical path of laser light, and each of which includes a half-wave plate and a Wollaston prism; a wave plate rotating mechanism configured to rotate each half-wave plate around the optical path; and a prism rotating mechanism configured to rotate each Wollaston prism around the optical path, wherein in each of the plurality of optical element units, the laser light is incident on the Wollaston prism through the half-wave plate, and branched into two beams of branched laser light.

According to a second aspect of the present invention, the laser optical system according to the first aspect includes a laser light adjusting unit configured to adjust branching ratios of the branched laser light by rotating the half-wave plate using the wave plate rotating mechanism, and adjust branching directions of the branched laser light by rotating the Wollaston prism using the prism rotating mechanism.

According to a third aspect of the present invention, the laser optical system according to the first or the second aspect includes an optical element unit moving mechanism configured to move each of the plurality of optical element units selectively between an inserting position at which the optical element unit is disposed on the optical path of the laser light and a retracting position at which the optical element unit is retracted from the optical path of the laser light.

According to a fourth aspect of the present invention, in the laser optical system according to any one of the first to the third aspects, the wave plate rotating mechanism rotates the half-wave plate to differentiate the branching ratios of the branched laser light.

According to a fifth aspect of the present invention, in the laser optical system according to any one of the first to the fourth aspects, the prism rotating mechanism rotates the Wollaston prism to adjust a machining width when laser machining is to be performed on a workpiece.

A laser machining device according to a sixth aspect of the present invention includes: a laser light source configured to emit laser light; the laser optical system according to any of the first to the fifth aspects; and a condenser lens configured to focus the laser light branched by the laser optical system on a workpiece.

A seventh aspect of the present invention is an adjustment method of a laser optical system including a plurality of optical element units which are arranged in series on an optical path of laser light and each of which includes a half-wave plate and a Wollaston prism, the laser optical system configured to branch the laser light incident on the Wollaston prism through the half-wave plate into two beams of branched laser light. The adjustment method includes: a step of adjusting branching ratios of the branched laser light by rotating the half-wave plate around the optical path; and a step of adjusting branching directions of the branched laser light by rotating the Wollaston prism around the optical path.

A laser machining method according to an eighth aspect of the present invention includes a step of performing laser machining by irradiating a workpiece with laser light emitted from a laser optical system which is adjusted by the adjustment method of the laser optical system according to the seventh aspect.

According to the present invention, by adjusting branching ratios and branching directions of branched laser light, it is possible to adjust laser light so as to satisfy criteria of laser machining.

### BRIEF DESCRIPTION OF THE DRAWINGS

FIG. 1 is a schematic view of a laser machining device according to an embodiment of the present invention.

FIG. 2 is a plan view of a wafer to be machined.

FIG. 3 is an explanatory diagram for explaining laser machining along an odd-numbered street.

FIG. 4 is an explanatory diagram for explaining laser machining along an even-numbered street.

FIG. 5 is a block diagram illustrating an example of a laser optical system.

FIG. 6A is an image showing an example of branching of laser light.

FIG. 6B is an image showing an example of branching of laser light.

FIG. 6C is an image showing an example of branching of laser light.

FIG. 7A is an image showing an example of branching ratios of laser light branched into eight beams (the number of units: 3).

FIG. 7B is an image showing an example of branching ratios of laser light branched into eight beams (the number of units: 3).

FIG. 8 is an image showing an example of branching directions of laser light branched into eight beams (the number of units: 3).

FIG. 9A is an image showing an example of branching directions of laser light branched into four beams (the number of units: 2).

FIG. 9B is an image showing an example of branching directions of laser light branched into four beams (the number of units: 2).

FIG. 10 is a flowchart showing a laser machining method according to one embodiment of the present invention.

FIG. 11 is a flowchart showing an adjustment process of the laser optical system.

FIG. 12 is a block diagram illustrating an example of the laser optical system upon adjustment of the laser optical system.

### DESCRIPTION OF THE EMBODIMENTS

An embodiment of a laser optical system and an adjustment method therefor, and a laser machining device and method according to the present invention will be described below with reference to the accompanying drawings.

### [Outline of Laser Machining]

In the present embodiment, to achieve criteria (1) to (3) of laser machining, energy per one beam is suppressed by branching laser light for machining into beams. Further, laser machining with one pass is achieved by using laser light branched into multiple beams. This may achieve the criterion (1): shortening a time period required for laser machining and the criterion (2): suppressing influence of heat.

As means for branching the laser light into beams, for example, it is conceivable to use a diffractive optical element (DOE). However, the diffractive optical element is low in optical path efficiency, which significantly reduces power of the branched laser light. Reduction in power of the laser light leads to an increase in time required for laser machining, which makes it difficult to achieve the criterion (1).

Further, as another means for branching the laser light into beams, it is conceivable to use a polarizing beam splitter (PBS). However, with the polarizing beam splitter, an angle formed by the branched laser light is too great, which makes it difficult to adjust optical paths of the branched laser light.

To address these, in the present embodiment, as means for branching the laser light into beams, the laser light is branched using a Wollaston prism (Wollaston Prism) with high optical path efficiency. Further, in the present embodiment, the laser light is branched into four or more beams by combining Wollaston prisms. In this manner, by obtaining laser light branched into multiple beams using Wollaston prisms, the laser light may be adjusted while securing power of the branched laser light, so that it is possible to achieve the above-described criteria.

### [Laser Machining Device]

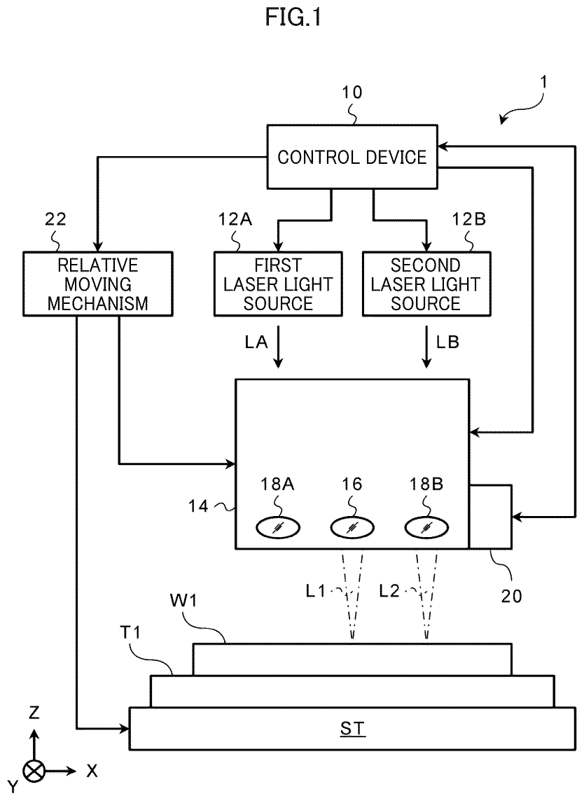

An example of a laser machining device will be described next with reference to FIG. 1.

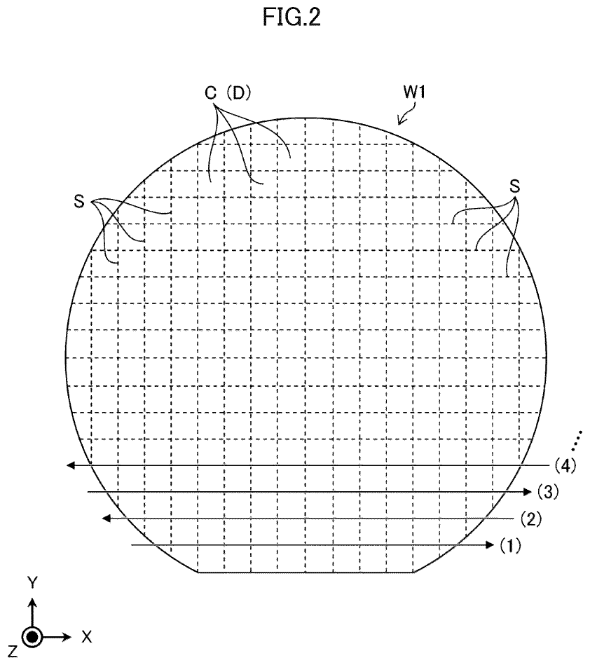

FIG. 1 is a schematic view of a laser machining device according to one embodiment of the present invention. As illustrated in FIG. 1, a laser machining device 1 performs laser machining (ablation grooving) on a wafer W1 as a preprocess prior to dividing the wafer W1 into chips C (see FIG. 2). Note that X, Y and Z directions in the drawing are perpendicular to each other. Among these directions, the X direction and the Y direction are horizontal directions, and the Z direction is a vertical direction. Here, the X direction corresponds to a machining feed direction of the present invention.

FIG. 2 is a plan view of the wafer W1 to be machined. As illustrated in FIG. 2, the wafer W1 is a stacked body in which a Low-k film and a functional film that forms a circuit are stacked on a surface of a substrate such as silicon. The wafer W1 is partitioned into regions by streets S (scheduled dividing lines) arranged in a grid shape. A device D that constitutes the chip C is provided in each of the partitioned regions.

The laser machining device 1 performs laser machining on the wafer W1 along the streets S for each street S as indicated in bracketed numbers (1) to (4), . . . , in the drawing so as to remove the Low-k film, and the like, on the substrate.

In this event, the laser machining device 1 alternately switches a relative moving direction for moving a laser optical system 14 to be described later, relatively to the wafer W1 in the X direction for each street S to reduce a takt time required for laser machining of the wafer W1.

For example, in a case where laser machining is performed along odd-numbered streets S indicated by the bracketed numbers (1), (3), . . . , in the drawing, the laser optical system 14 is moved toward an outward direction X1 that is one direction along the X direction relative to the wafer W1. On the other hand, in a case where laser machining is performed along even-numbered streets S indicated by the bracketed numbers (2), (4), . . . , in the drawing, the laser optical system 14 is moved toward an opposite direction along the X direction, that is, in a return direction X2 that is opposite to the outward direction X1 relative to the wafer W1.

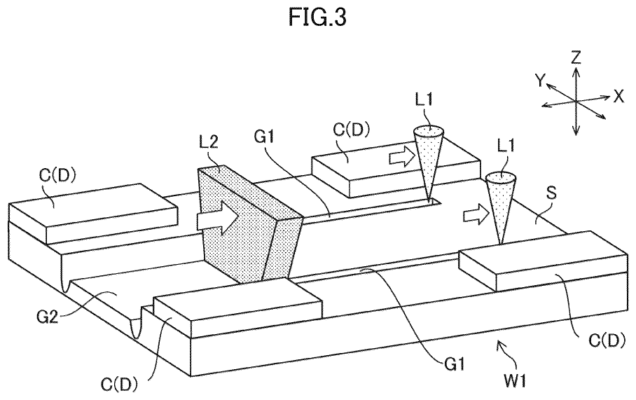

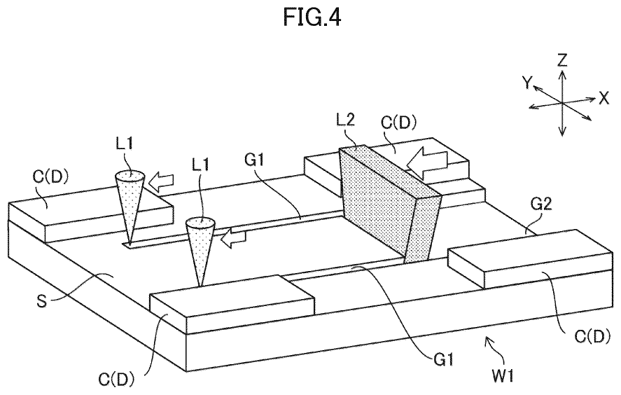

FIG. 3 is an explanatory diagram for explaining laser machining along the odd-numbered street S. FIG. 4 is an explanatory diagram for explaining laser machining along the even-numbered street S.

As illustrated in FIG. 3 and FIG. 4, in the present embodiment, trimming machining and hollowing machining are performed at the same time (in parallel) as laser machining. The trimming machining is laser machining to be performed using two beams of first laser light (split laser) L1 and laser machining of forming a trimming groove G1 (two rows of a first groove, ablation grooves) which is comprised of two rows parallel to each other along the street S.

The hollowing machining is laser machining of forming a hollow groove G2 (second groove, ablation groove) between the two rows of the trimming groove G1 formed through the trimming machining. In the present embodiment, the hollowing machining is performed using second laser light (line laser) L2 having a radius greater than a radius of the two beams of the first laser light L1.

In the laser machining device 1, in either case where the laser optical system 14 is moved in the outward direction X1 or moved in the return direction X2 relative to the wafer W1, the trimming machining is performed prior to the hollowing machining.

As illustrated in FIG. 1, the laser machining device 1 includes a control device 10, a first laser light source 12A, a second laser light source 12B, the laser optical system 14, a microscope 20, and a relative moving mechanism 22.

A stage ST moves along the X direction and the Y direction by the relative moving mechanism 22 and rotates around the Z axis under control of the control device 10.

The first laser light source 12A emits laser light LA that is pulse laser light that satisfies conditions (such as a wavelength, a pulse width and a repetition frequency) appropriate for trimming machining to the laser optical system 14. The second laser light source 12B emits laser light LB that is pulse laser light that satisfies conditions (such as a wavelength, a pulse width and a repetition frequency) appropriate for hollowing machining to the laser optical system 14.

The laser optical system 14 forms two beams of first laser light L1 for trimming machining based on the laser light LA from the first laser light source 12A. Further, the laser optical system 14 forms one beam of second laser light L2 for hollowing machining based on the laser light LB from the second laser light source 12B. Then, the laser optical system 14 emits (radiates) the two beams of the first laser light L1 toward the street S from a first condenser lens 16. Further, the laser optical system 14 selectively emits (radiates) the second laser light L2 toward the street S from a first condenser lens 18A or a second condenser lens 18B under control of the control device 10.

Still further, the laser optical system 14 is moved in the Y direction and the Z direction by the relative moving mechanism 22 under control of the control device 10.

The microscope 20 is fixed at the laser optical system 14 and moves integrally with the laser optical system 14. The microscope 20 captures an image of an alignment reference (not illustrated) formed on the wafer W1 before the trimming machining and the hollowing machining. Further, the microscope 20 captures an image of the two rows of the trimming groove G1 and the hollow groove G2 formed along the street S by the trimming machining and the hollowing machining. The captured images (image data) captured by the microscope 20 are output to the control device 10 and displayed at a monitor (not illustrated) by the control device 10.

The relative moving mechanism 22, which includes an XYZ actuator and a motor, moves the stage ST in the X and Y directions, rotates the stage ST around a rotational axis and moves the laser optical system 14 in the Z direction under control of the control device 10. This enables the relative moving mechanism 22 to move the laser optical system 14 relative to the stage ST and the wafer W1. Note that as long as the laser optical system 14 can be moved in the respective directions (including rotation) relative to the stage ST (wafer W1), a relative moving method is not particularly limited.

The relative moving mechanism 22 is driven so as to perform position adjustment (alignment) of the laser optical system 14 with respect to a machining start position that is one end of the street S of the machining target, and relative movement of the laser optical system 14 in the X direction (the outward direction X1 or the return direction X2) along the street S. Further, the relative moving mechanism 22 is driven to rotate the stage ST by 90 degrees, so that each street S along the Y direction of the wafer W1 may be made parallel to the X direction that is the machining feed direction.

The control device 10 is, for example, constituted with a personal computer. The control device 10 includes various kinds of processors (such as, for example, a central processing unit (CPU) and a graphics processing unit (GPU)), a memory and a storage device. Note that various kinds of functions of the control device 10 may be implemented by one processor or may be implemented by the same type or different types of processors. The control device 10 comprehensively controls operation of the first laser light source 12A, the second laser light source 12B, the laser optical system 14, the microscope 20, the relative moving mechanism 22, and the like.

### [Laser Optical System]

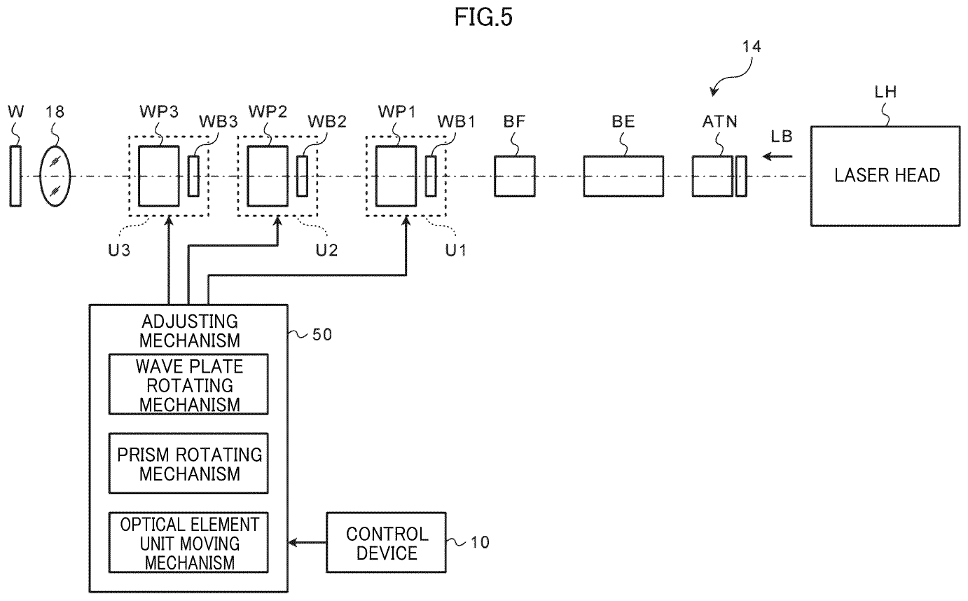

An example of the laser optical system 14 will be described next with reference to FIG. 5. FIG. 5 is a block diagram illustrating an example of an illumination optical system. In the following description, while an example where the laser light LB from the second laser light source 12B is branched will be described, the present invention may be also applied to the laser light LA. Further, an aspect of branching of the laser light B is similar between the second condenser lens 18A side and the second condenser lens 18B side, and thus, the second condenser lenses 18A and 18B will be described as a condenser lens 18 in the following description.

In the laser optical system 14 illustrated in FIG. 5, among the optical element units U1 to U3 for branching the laser light LB, two or more optical element units are selectively put on or taken out from an optical path of the laser light LB so as to arrange the two or more optical element units in series on the optical path, thereby enabling to output branched laser light.

FIG. 5 illustrates the optical path of the laser light LB from a laser head LH of the second laser light source 12B to the workpiece W.

The laser head LH outputs the laser light LB emitted from a laser oscillator of the second laser light source 12B.

As illustrated in FIG. 5, as examples of optical elements for adjusting the laser light LB, an attenuator ATN, a beam expander BE and a beam forming element BF are arranged between the laser head LH, and the optical element units U1 to U3.

The attenuator ATN is an optical element for adjusting (attenuating) a level of the laser light LB to an appropriate level (amplitude).

The beam expander BE is an optical element for adjusting (expanding) a beam diameter of the laser light LB and forming collimated light (parallel light) from the laser light LB.

The beam forming element BF is an optical element for adjusting a beam profile (such as, for example, a shape of the beam and intensity distribution of the beam) of the laser light LB.

As illustrated in FIG. 5, the optical element units (hereinafter, referred to as “units”) U1 to U3 for branching the laser light LB are arranged between the above-described optical elements for adjusting the laser light LB and the condenser lens 18. The optical element units U1 to U3 respectively include: half-wave plates (2/2 wave plates) WB1 to WB3; and Wollaston prisms WP1 to WP3.

The half-wave plates WB1 to WB3 are optical elements including birefringent materials. The half-wave plates WB1 to WB3 generate a phase difference of 180 degrees between orthogonal polarization components of the laser light LB. In a case where linearly polarized light is incident on the half-wave plates WB1 to WB3 at an angle θ with respect to optical axes of the half-wave plates WB1 to WB3, the linearly polarized light is emitted with a vibration direction rotated by 2θ.

The Wollaston prisms WP1 to WP3 respectively branch one beam of the laser light LB incident through the half-wave plates WB1 to WB3, into two beams. In other words, the Wollaston prism WP1 branches one beam of the laser light LB into two beams, the Wollaston prism WP2 branches the branched two beams of the laser light LB into four beams, and the Wollaston prism WP3 branches the branched four beams of the laser light LB into eight beams.

In the present embodiment, the number of beams to be branched from the laser light LB may be adjusted by changing the number of the units U1 to U3 on the optical path of the laser light LB.

The half-wave plates WB1 to WB3 are arranged on an upstream side of the Wollaston prisms WP1 to WP3 in the respective units U1 to U3, and are used to adjust energy ratios of the branched laser light LB.

The laser light LB branched into four beams or eight beams by the units U1 to U3 is focused on the workpiece W by the condenser lens 18.

An adjusting mechanism 50 controls the units U1 to U3 in accordance with a control signal from the control device 10. The adjusting mechanism 50 includes a drive unit (a wave plate rotating mechanism and a prism rotating mechanism. For example, a mechanism (stage) for holding optical elements, an actuator, or the like) for controlling angles of the half-wave plates WB1 to WB3 included in the units U1 to U3 and controlling positions and angles of the Wollaston prisms WP1 to WP3. Further, the adjusting mechanism 50 includes an retraction controlling mechanism (an optical element unit moving mechanism. For example, a ball screw mechanism, an actuator, or the like) for moving the units U2 and U3 between an inserting position and a retracting position on the optical path of the laser light LB, so that the units U2 and U3 are put on or taken out (retractable) from the optical path. In other words, the control device 10 and the adjusting mechanism 50 function as a laser light adjusting unit.

The adjusting mechanism 50 may adjust energy intensity of the laser light LB branched into four beams or eight beams by rotating the half-wave plates WB1 to WB3 around the optical path of the laser light LB. Further, the adjusting mechanism 50 may adjust an emission direction (branching direction) of the laser light LB branched into four beams or eight beams by rotating the Wollaston prisms WP1 to WP3 around the optical path of the laser light LB.

Note that the number and arrangement of the units U1 to U3 are not limited to those in FIG. 5, and, for example, four or more units may be provided (laser light may be branched into 16 or more beams). Further, for example, while in the present embodiment, the units U2 and U3 on the downstream side are configured to be retractable (put on and taken out) from the optical path of the laser light LB, any of three units U1 to U3 may be configured to be retractable.

### [Example of Branching of Laser Light]

An example (the number of beams to be branched into, branching ratios and branching directions) of branching of the laser light LB will be described next.

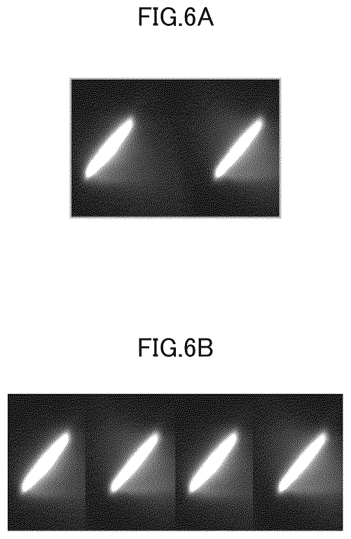

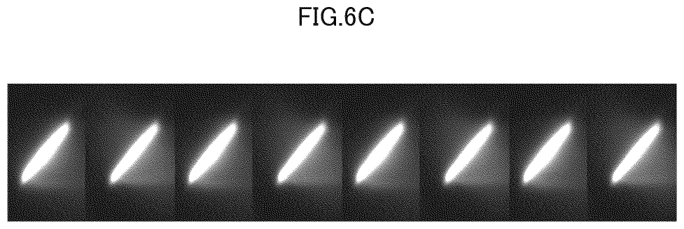

FIGS. 6A, 6B and 6C are images illustrating examples of branching of the laser light. Examples illustrated in FIGS. 6A, 6B and 6C show examples where the laser light LB is respectively branched into two beams, four beams, and eight beams by the units U1 to U3. In the example illustrated in FIGS. 6A, 6B and 6C, spots of the branched laser light are linearly arranged along the machining proceeding direction (machining feed direction). In this manner, by changing the number of units U1 to U3 to adjust the number of beams to be branched into, it is possible to perform laser machining with one pass or reduced number of passes while suppressing energy intensity per one beam. It is therefore possible to achieve the criterion (1): shortening a time period required for laser machining and the criterion (2): suppressing influence of heat.

### (Adjustment Example of Branching Ratios)

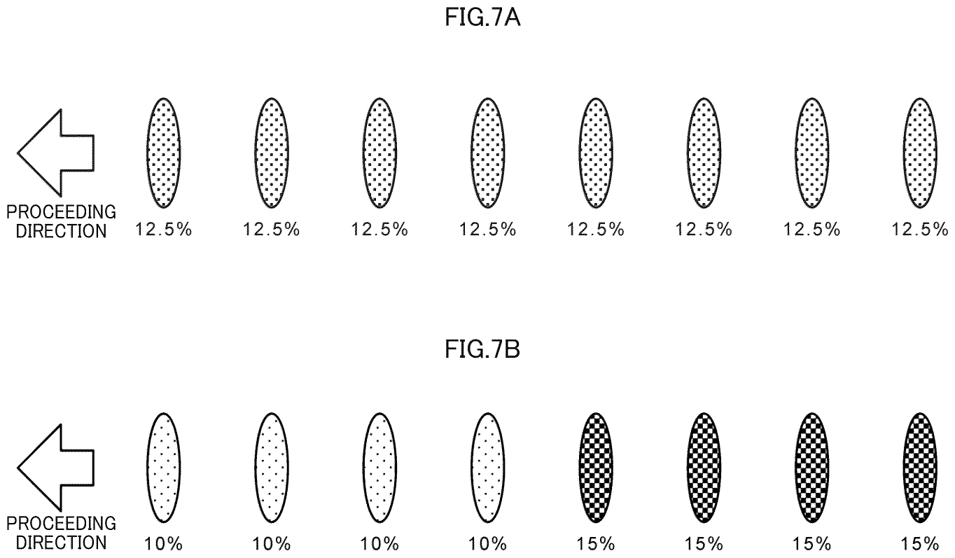

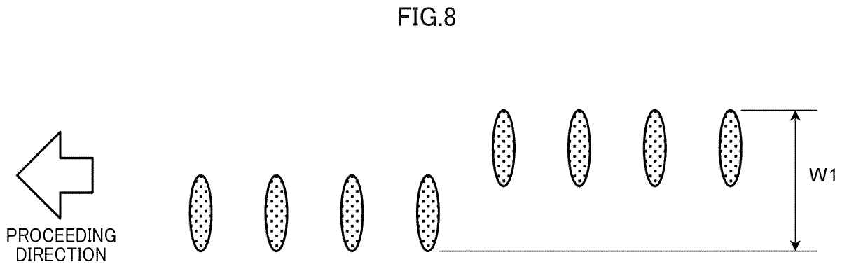

FIGS. 7A and 7B are images showing examples of branching ratios of laser light branched into eight beams (the number of units: 3).

FIG. 7A illustrates an example where branching ratios of the laser light LB branched into eight beams are made equal. In the example illustrated in FIG. 7A, in a case where a total of energy (intensity) of the laser light branched into eight beams is set at 100%, energy of each branched beam of the laser light is 12.5%.

FIG. 7B illustrates an example where branching ratios of the laser light LB branched into eight beams are made different. In the example illustrated in FIG. 7B, in a case where a total of energy (intensity) of the laser light branched into eight beams is set at 100%, energy of four branched beams of the laser light on the downstream side along the machining proceeding direction is 10%, and energy of four branched beams of the laser light on the upstream side is 15%.

Note that the branching ratios are not limited to those described above, and the branching ratios may be different among eight branched beams of the laser light.

As described above, by appropriately allocating energy to be radiated on a surface of the workpiece W by making the branching ratios of the branched laser light different from each other, it is possible to achieve the criterion (2): suppressing influence of heat further effectively.

### (Adjustment Example of Branching Directions)

FIG. 8 is an image showing an example of branching directions of the laser light branched into eight beams (the number of units is 3).

In the example illustrated in FIG. 8, there are four branched beams of the laser light on the downstream side and four branched beams of the laser light on the upstream side along the machining proceeding direction, and the four branched beams of the laser light on the downstream side are displaced from the four branched beams of the laser light on the upstream side in a direction perpendicular to the machining proceeding direction. As described above, by adjusting the branching directions, it is possible to adjust a machining width on the surface or inside of the workpiece W. For example, it is possible to form a machining groove, or the like, with a large width W1 in a direction perpendicular to the machining proceeding direction with one pass.

Note that the branching directions are not limited to the example in FIG. 8, and positions of the spots of the branched laser light may be made alternating for each one beam or for each of two beams.

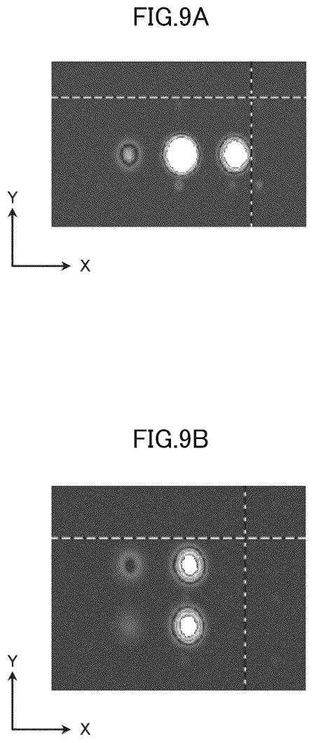

FIGS. 9A and 9B are images showing examples of branching directions of the laser light branched into four beams (the number of units is 2). FIGS. 9A and 9B respectively illustrate cases where two units of the units U1 and U2 are arranged on the optical path of the laser light LB.

FIG. 9A illustrates an example where positions of the spots of the branched laser light are linearly located. In the example illustrated in FIG. 9A, two branched beams of the laser light overlap with each other at the position of the spot at the center in the X direction.

FIG. 9B illustrates an example where the positions of the spots of the branched laser light are arranged in a matrix shape of 2×2 in the X and Y directions. The spot arrangement in FIG. 9B is obtained by rotating relative rotational angle between the Wollaston prisms WP1 and WP2 by 90 degrees with respect to the angle in a case of FIG. 9A.

As described above, by adjusting the branching directions of the branched laser light, it is possible to achieve the criterion (3): obtaining a desired machining result (such as, for example, a depth of a machining groove or a depth position or a size of a laser machining region).

Further, by appropriately allocating positions and energy of the spots of the branched laser light at the workpiece W, it is possible to achieve the criterion (1): shortening a time period required for laser machining and the criterion (2): suppressing influence of heat. For example, by adjusting the branching ratios and the branching directions of the branched laser light, it is, for example, possible to perform trimming machining with one pass.

Note that while in the above-described embodiment, the number of beams to be branched into is set at 2N with respect to the number of units N, the present invention is not limited to this. As illustrated in FIG. 9A, by adjusting branching directions of branched beams of the laser light so that part of the branched laser light is superimposed, it is possible to arbitrarily change the number, positions and intensity of spots on the workpiece W or inside the workpiece W.

### [Laser Machining Method]

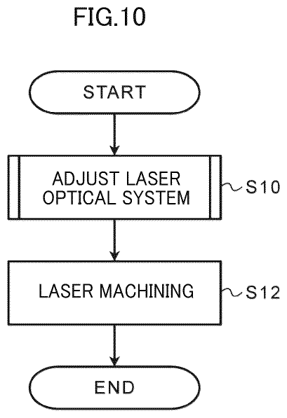

An adjustment method and a laser machining method of the laser optical system 14 according to the present embodiment will be described next with reference to FIG. 10 to FIG. 12.

In the present embodiment, as illustrated in FIG. 10, after the laser optical system 14 is adjusted, and the branching ratios and the branching directions of the branched laser light are adjusted (step S10), laser machining is performed (step S12).

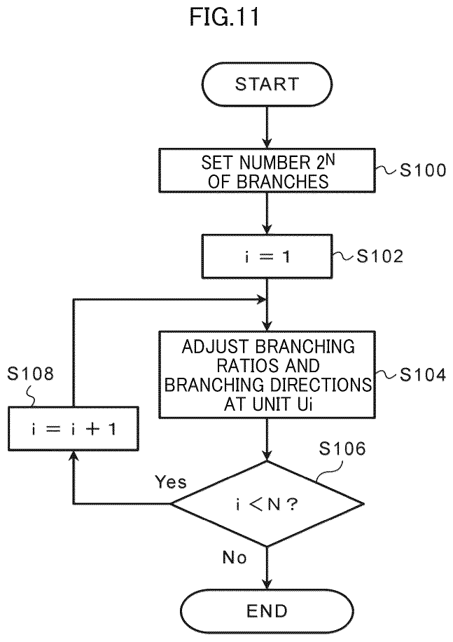

An adjustment process (step S10) of the laser optical system 14 will be described below with reference to FIG. 11.

In the adjustment process of the laser optical system 14, first, as illustrated in FIG. 11, the number 2^{N} of beams to be branched from the laser light is set. That is, the number N of units U1 to U3 to be used for branching the laser light is set (step S100). Note that in the example illustrated in FIG. 5, N is 2 or 3 (the number of beams to be branched into is 4 or 8).

Then, the branching ratios and the branching directions are adjusted sequentially from the unit U1 on the upstream side (step S102 to S108).

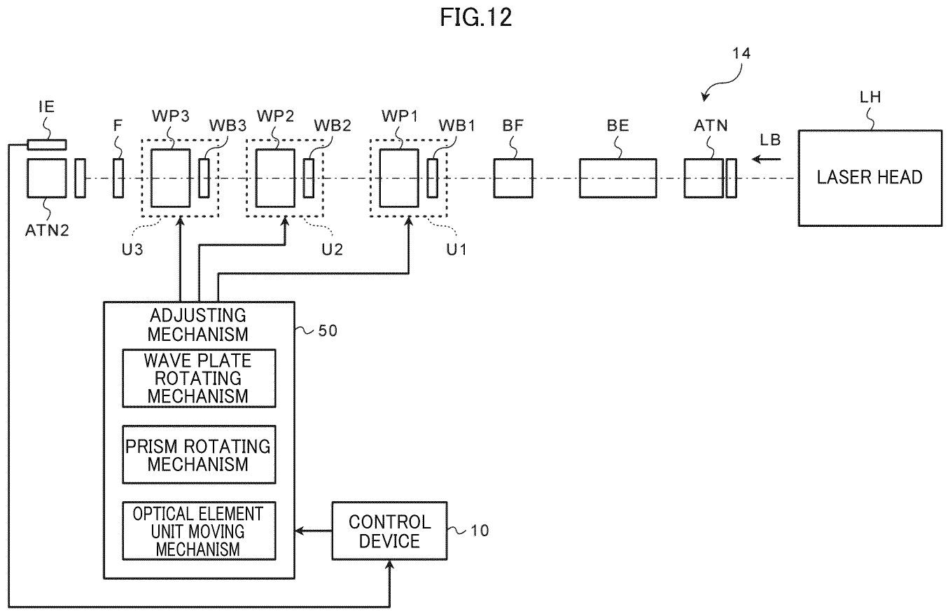

The adjustment of the units U1 to U3 according to the present embodiment is performed by arranging a condenser lens F for adjustment, an attenuator ATN2, and an imaging element IE on the downstream side of the units U1 to U3 as illustrated in FIG. 12.

Because an angle formed by the branched laser light branched by the units U1 to U3 is minute, the branched laser light are substantially parallel to each other. The condenser lens F for adjustment is an optical element for focusing the branched laser light branched by the units U1 to U3 to clarify and adjust components of each beam of the branched laser light.

The attenuator ATN2 is an optical element for adjusting (attenuating) a level of the branched laser light incident on the imaging element IE to an appropriate level (amplitude).

The imaging element IE is an optical element for capturing a spot image of the branched laser light. The imaging element IE is, for example, a charge coupled device (CCD) or a complementary metal oxide semiconductor (CMOS).

First, in a case where the unit U1 on the most upstream side is adjusted, the units U2 and U3 are retracted from the optical path. Then, a spot image of the two branched beams of the laser light from the unit U1 is captured by the imaging element IE.

Then, the control device 10 calculates branching ratios (intensity) and branching directions (positions) of the branched laser light from the spot image. Then, the control device 10 controls the adjusting mechanism 50 to rotate the half-wave plate WB1 so as to obtain desired branching ratios and rotate the Wollaston prism WP1 to obtain desired branching directions.

In a case where the adjustment of the unit U1 is finished, then, the unit U2 is put on the optical path, and its adjustment is performed. In other words, a spot image of four branched beams of the laser light from the unit U2 is captured by the imaging element IE, and the half-wave plate WB2 and the Wollaston prism WP2 are rotated by the adjusting mechanism 50 so as to obtain desired branching ratios and branching directions.

Then, step S104 to step S108 are repeated, and in a case where the adjustment for all of the N units is finished (step S106: No), the adjustment process for the laser optical system 14 ends.

As described above, by performing adjustment sequentially from the unit U1 on the upstream side, it is possible to obtain branched laser light with desired branching ratios and branching directions.

Note that while in the present embodiment, the half-wave plates WB1 to WB3 and the Wollaston prisms WP1 to WP3 are automatically adjusted by the adjusting mechanism 50, it is also possible to enable manual adjustment of the half-wave plates WB1 to WB3 and the Wollaston prisms WP1 to WP3. For example, the spot image captured by the imaging element IE may be output to a monitor, and an engineer may manually operate and adjust the adjusting mechanism 50 while observing the spot image at the monitor.

Further, while in the present embodiment, the unit on the upstream side is adjusted in a state where the unit on the downstream side is retracted from the optical path, the present invention is not limited to this. For example, in adjustment of each unit, the imaging element IE may be moved between the respective units in a state where the unit to be used for laser machining is put on the optical path.

### REFERENCE SIGNS LIST

1 Laser machining device
10 Control device
12A First laser light source
12B Second laser light source
14 Laser optical system
16 First condenser lens
18A, 18B Second condenser lens
20 Microscope
22 Relative moving mechanism
50 Adjusting mechanism
LH Laser head
ATN, ATN2 Attenuator
BE Beam expander
BF Beam forming element
WP1 to WP3 Wollaston prism
WB1 to WB3 Half-wave plate
IE Imaging element

What is claimes is:

1. A laser optical system comprising:
a plurality of optical element units which are arranged in series on an optical path of laser light, and each of which includes a half-wave plate and a Wollaston prism;
a wave plate rotating mechanism configured to rotate each half-wave plate around the optical path; and
a prism rotating mechanism configured to rotate each Wollaston prism around the optical path,
wherein in each of the plurality of optical element units, the laser light is incident on the Wollaston prism through the half-wave plate, and branched into two beams of branched laser light.

2. The laser optical system according to claim 1, comprising:
a laser light adjusting unit configured to adjust branching ratios of the branched laser light by rotating the half-wave plate using the wave plate rotating mechanism, and adjust branching directions of the branched laser light by rotating the Wollaston prism using the prism rotating mechanism.

3. The laser optical system according to claim 1, comprising:
an optical element unit moving mechanism configured to move each of the plurality of optical element units selectively between an inserting position at which the optical element unit is disposed on the optical path of the laser light and a retracting position at which the optical element unit is retracted from the optical path of the laser light.

4. The laser optical system according to claim 1,
wherein the wave plate rotating mechanism rotates the half-wave plate to differentiate the branching ratios of the branched laser light.

5. The laser optical system according to claim 1,
wherein the prism rotating mechanism rotates the Wollaston prism to adjust a machining width when laser machining is to be performed on a workpiece.

6. A laser machining device comprising:
a laser light source configured to emit laser light;
the laser optical system according to claim 1; and
a condenser lens configured to focus the laser light branched by the laser optical system on a workpiece.

7. An adjustment method of a laser optical system comprising a plurality of optical element units which are arranged in series on an optical path of laser light and each of which includes a half-wave plate and a Wollaston prism, the laser optical system configured to branch the laser light incident on the Wollaston prism through the half-wave plate into two beams of branched laser light, the adjustment method comprising:
a step of adjusting branching ratios of the branched laser light by rotating the half-wave plate around the optical path; and
a step of adjusting branching directions of the branched laser light by rotating the Wollaston prism around the optical path.

8. A laser machining method comprising:
a step of performing laser machining by irradiating a workpiece with laser light emitted from a laser optical system which is adjusted by the adjustment method of the laser optical system according to claim 7.
